(19) United States
(12) Patent Application Publication
(10) Pub. No.: US 2019/0294129 A1
(43) Pub. Date: Sep. 26, 2019

(54) WORK SUPPORT SYSTEM AND INFORMATION PROCESSING METHOD

(71) Applicant: TOYOTA JIDOSHA KABUSHIKI KAISHA, Toyota-shi (JP)

(72) Inventors: Takahiro MUTA, Mishima-shi (JP); Eisuke ANDO, Nagoya-shi (JP); Takao HISHIKAWA, Nagoya-shi (JP)

(73) Assignee: TOYOTA JIDOSHA KABUSHIKI KAISHA, Toyota-shi (JP)

(21) Appl. No.: 16/297,188

(22) Filed: Mar. 8, 2019

(30) Foreign Application Priority Data
Mar. 20, 2018 (JP) 2018-052996

(51) Int. Cl. G05B 15/02; G06Q 10/10; G05D 1/02; B60H 1/00

(52) U.S. Cl. CPC G05B 15/02; G06Q 10/10; G05D 2201/0213; B60H 1/00657; G05D 1/0287

(57) ABSTRACT

To provide a support technique of enabling a user to appropriately execute predetermined work within a mobile body. A work support system supports execution of work of a user using predetermined facility in a first mobile body including the predetermined facility among one or more mobile bodies. The work support system includes a judging unit configured to judge whether a user needs a break on the basis of user information relating to the user who is executing work within the first mobile body, and a managing unit configured to instruct the first mobile body to provide predetermined service to the user when it is judged that the user needs a break.

### CROSS REFERENCE TO RELATED APPLICATION

This application claims the benefit of Japanese Patent Application No. 2018-052996, filed on Mar. 20, 2018, which is hereby incorporated by reference herein in its entirety.

### BACKGROUND

### Technical Field

The present disclosure relates to a work support system which supports a user of a mobile body which functions as a mobile office, and an information processing method.

### Description of the Related Art

In recent years, study of providing service using a mobile body which autonomously travels has been underway. For example, Patent document 1 discloses a mobile office which is achieved by causing a plurality of vehicles in which office equipment is disposed in a car so as to be able to be used, to gather at a predetermined location and coupling the vehicles to a connection car.

### CITATION LIST

### Patent Document

[Patent document 1] Japanese Patent Laid-Open No. 9-183334

### SUMMARY

As a service form of a mobile body which autonomously travels, for example, a form can be considered in which space within the mobile body is provided as space in which a user does predetermined work. For example, by predetermined facility such as office equipment to be used by the user to execute predetermined work being placed within the mobile body, space within the mobile body can be provided as space in which the user. executes the predetermined work. The user of the service can, for example, move to a destination (for example, a place of work or a business trip destination) while executing predetermined work within the mobile body.

By the way, content of work to be executed within the mobile body varies depending on the user. Further, efficiency of work to be executed within the mobile body is also different depending on the user. Therefore, there can occur a case where the user is unable to appropriately complete work to be executed within the mobile body depending on content of work to be dealt with by the user.

The present disclosure has been made in view of such a problem, and an object of the present disclosure is to provide a support technique which enables the user to appropriately execute predetermined work within the mobile body.

To achieve the above-described object, one aspect of the present disclosure is exemplified by a work support system. The present work support system supports execution of work of a user using predetermined facility in a first mobile body including the predetermined facility among one or more mobile bodies. The present work support system may include a judging unit configured to judge whether a user needs a break on the basis of user information relating to the user who is executing work within the first mobile body, and a managing unit configured to instruct the first mobile body to provide predetermined service to the user when it is judged that the user needs a break.

According to such a configuration, when it is judged that the user who is executing work within an office vehicle is put into a state where the user needs a break, it is possible to provide predetermined service for a break to the user in accordance with preference. It is possible to provide a support technique which enables the user to appropriately execute predetermined work within the mobile body.

Further, in another aspect of the present disclosure, the user information may include at least biological information acquired from the user who is executing work within the first mobile body. According to such a configuration, it is possible to judge whether the user needs a break on the basis of transition and change of a state indicated by the biological information.

Further, in another aspect of the present disclosure, the user information may include acquired time, the biological information may include an image acquired from the user, and the judging unit may judge whether or not the user needs a break on the basis of at least one of the number of times of occurrence of a biological phenomenon in the acquired biological information per unit period and a proportion of a work period which is determined from the image in an elapsed time period. According to such a configuration, it is possible to improve judgement accuracy as to whether the user needs a break.

Further, in another aspect of the present disclosure, when it is judged that the user needs a break, the managing unit may notify the first mobile body of one of acoustic data, image data and news data selected in accordance with preference of the user. According to such a configuration, it is possible to provide service for a break for allowing the user to get refreshed on the basis of data selected in accordance with intention of the user.

Further, in another aspect of the present disclosure, when it is judged that the user needs a break, the managing unit may notify the first mobile body of a control instruction of controlling at least one of: lighting, daylighting, and air conditioning within the first mobile body, view from the first mobile body, and tilt of a chair to be used by the user in accordance with preference of the user. According to such a configuration, it is possible to provide an environment state appropriate for a break via equipment controlled in accordance with intention of the user.

Further, in another aspect of the present disclosure, when it is judged that the user needs a break, the managing unit may instruct a second mobile body which is able to provide goods or service among the one or more mobile bodies to provide the goods or the service to the user within the first mobile body. According to such a configuration, it is possible to provide various kinds of service of the second mobile body which provides goods or service to the user during a break of the user.

Further, another aspect of the present disclosure is exemplified by an information processing method executed by a computer of a work support system. Still further, another aspect of the present disclosure is exemplified by a program to be executed by a computer of an information system. Note that the present disclosure can be regarded as a work support system or an information processing apparatus which includes at least part of the above-described processing and means. Further, the present disclosure can be regarded as an information processing method which executes at least part of processing performed by the above-described means. Still further, the present disclosure can be regarded as a computer readable storage medium in which a computer program for causing a computer to execute this information processing method is stored. The above-described processing and means can be freely combined and implemented unless technical contradiction occurs.

According to the present disclosure, it is possible to provide a support technique which enables a user to appropriately execute predetermined work within a mobile body.

### BRIEF DESCRIPTION OF THE DRAWINGS

FIG. 1 is a diagram illustrating a functional configuration of a mobile body system to which the work support system according to an embodiment is applied;

FIG. 2 is a perspective view illustrating appearance of an office vehicle;

FIG. 3 is a schematic plan view illustrating a configuration of the in-vehicle space of an office vehicle;

FIG. 4 is a diagram illustrating a plan view of arrangement of a sensor, a display, a drive apparatus and a control system mounted on an office vehicle, seen from a lower side of the vehicle;

FIG. 5 is a diagram illustrating a hardware configuration of the control system mounted on an office vehicle and each unit relating to the control system;

FIG. 6 is a diagram illustrating detailed configurations of a biosensor and an environment adjusting unit mounted on an office vehicle;

FIG. 7 is a diagram illustrating a hardware configuration of a center server;

FIG. 8 is a diagram illustrating an example of the functional configuration of a center server;

FIG. 9 is a diagram illustrating an example of the functional configuration of a management server;

FIG. 10 is a diagram explaining vehicle operation information;

FIG. 11 is a diagram illustrating an example of a display screen to be displayed on a display with a touch panel;

FIG. 12 is a diagram explaining office vehicle information;

FIG. 13 is a diagram explaining store vehicle information;

FIG. 14 is a diagram explaining distributed data management information;

FIG. 15 is a diagram explaining user state management information;

FIG. 16 is a flowchart illustrating an example of processing of managing an office vehicle and a store vehicle;

FIG. 17 is a flowchart illustrating an example of processing of managing the state of a user who is executing work;

FIG. 18 is a flowchart illustrating an example of processing relating to provision of service for a break;

FIG. 19 is a flowchart illustrating an example of detailed processing of the processing in S26;

FIG. 20 is a diagram explaining user state management information in modified example;

FIG. 21 is a flowchart illustrating an example of processing in modified example.

### DESCRIPTION OF THE EMBODIMENTS

A work support system according to an embodiment will be described below with reference to the drawings. The following configuration of the embodiment is an example, and the present work system is not limited to the configuration of the embodiment.

<1. System Configuration>

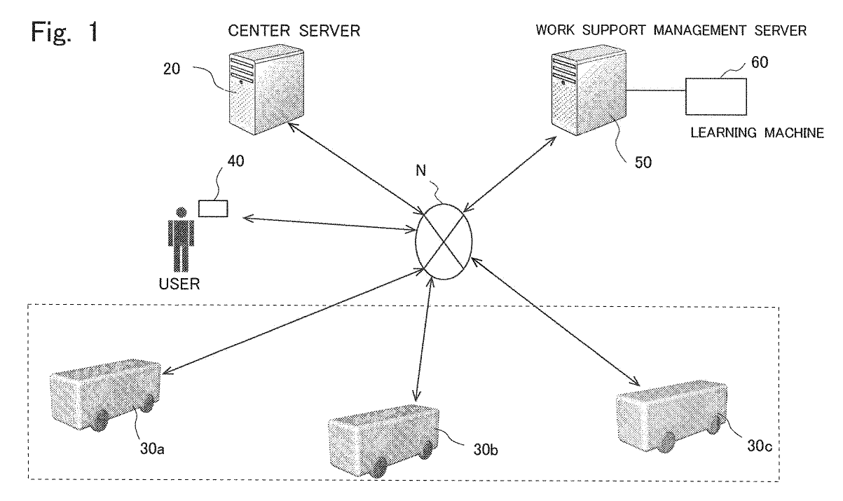

FIG. 1 is a diagram illustrating a functional configuration of a mobile body system to which the work support system according to the present embodiment is applied. The work support system 1 according to the present embodiment functions as part of the mobile body system or a complement system which cooperates with the mobile body system.

First, outline of the mobile body system will be described. The mobile body system includes a plurality of autonomously traveling vehicles 30a, 30b and 30c which autonomously travel on the basis of a provided command, and a center server 20 which issues the command. In the following description, the autonomously traveling vehicle will be also referred to as a “vehicle”, and the plurality of autonomously traveling vehicles 30a, 30b and 30c will be also collectively referred to as a “vehicle 30”.

The vehicle 30 is an automated driving vehicle which provides predetermined mobility service in accordance with various needs of the user, and is a vehicle which can autonomously travel on a road. Further, the vehicle 30 is a multipurpose mobile body which can change exterior and interior of the own vehicle and can arbitrarily select a vehicle size in accordance with application and purpose of mobility service to be provided. Examples of such a multipurpose mobile body which can autonomously travel can include, for example, a self-propelled electric vehicle called an Electric Vehicle (EV) palette. The vehicle 30 provides predetermined mobility service such as a work environment by a mobile office, movement of the user or transport of baggage and sales of goods to the user in accordance with needs of the user via a user terminal 40 or an arbitrary user.

The center server 20, which is an apparatus which manages the plurality of vehicles 30 constituting the mobile body system, issues an operation command to each vehicle 30. The vehicle 30 creates an operation plan in response to the operation command from the center server 20 and autonomously travels to a destination in accordance with the operation plan. Note that the vehicle 30 includes means for acquiring location information, acquires location information with a predetermined period and transmits the location information to the center server 20 and a management server 50. The user terminal 40 is, for example, a small computer such as a smartphone, a mobile phone, a tablet terminal, a personal digital assistant and a wearable computer (such as a smart watch). However, the user terminal 40 may be a PC (Personal Computer) connected to the center server 20 and a work support management server 50 via a network N.

In the mobile body system illustrated in FIG. 1, the center server 20, the vehicle 30 and the user terminal 40 are connected to one another via the network N. Further, the work support management server 50 (hereinafter, also simply referred to as a “management server 50”) which constitutes the work support system 1 of the present embodiment is connected to the network N. The network N includes a public network such as the Internet, a wireless network of a mobile telephone network, a private network such as a VPN (Virtual Private Network) and a network such as a LAN (Local Area Network). A plurality of other center servers 20, vehicles 30, user terminals 40 and management servers 50 which are not illustrated can be connected to the network N.

The vehicle 30 which constitutes the mobile body system includes an information processing apparatus and a communication apparatus for controlling the own vehicle, providing a user interface with the user who utilizes the own vehicle and transmitting and receiving information to/from various kinds of servers on the network. In addition to processing which can be executed by the vehicle 30 alone, the vehicle 30 provides functions and service added by the various kinds of servers on the network to the user in cooperation with the various kinds of servers on the network.

For example, the vehicle 30 has a user interface controlled by a computer, accepts a request from the user, responds to the user, executes predetermined processing in response to the request from the user, and reports a processing result to the user. The vehicle 30 accepts speech, an image or an instruction from the user from input/output equipment of the computer, and executes processing. However, the vehicle 30 notifies the center server 20 and the management server 50 of the request from the user for a request which is unable to be processed alone among the requests from the user, and executes processing in cooperation with the center server 20 and the management server 50. The request which is unable to be processed by the vehicle 30 alone can include, for example, requests for acquisition of information from a database on the center server 20 and the management server 50, recognition or inference by learning machine 60 which cooperates with the management server 50, or the like.

Note that the vehicle 30 does not always have to be an unmanned vehicle, and a sales staff, a service staff, a maintenance staff, or the like, who provide the service may be on board in accordance with application and purpose of the mobility service to be provided. Further, the vehicle 30 does not always have to be a vehicle which always autonomously travels. For example, the above-described staff may drive the vehicle or assist driving of the vehicle in accordance with circumstances. While, in FIG. 1, three vehicles (vehicles 30a, 30b and 30c) are illustrated, the mobile body system includes a plurality of vehicles 30. The plurality of vehicles 30 which constitute the mobile body system is one example of “one or more mobile bodies”.

The work support system 1 according to the present embodiment includes the vehicle 30 which functions as a mobile type office (hereinafter, also referred to as an “office vehicle 30W”) and the management server (work support management server) 50 in the configuration. At the office vehicle 30W, for example, predetermined facility such as office equipment to be used by the user who reserves utilization to execute predetermined work is placed within the vehicle. Then, the office vehicle 30W provides space within the vehicle in which the predetermined facility is placed to the user as space in which the user executes predetermined work. A utilization form of the office vehicle 30W is arbitrary, and, for example, work such as a task and movie watching may be executed while the office vehicle 30W moves to a destination such as a place of work and a business trip destination from home, or the above-described predetermined work may be executed while the vehicle is parked or stopped at a destination such as on a road and open space at which the office vehicle 30W can be parked or stopped. The “office vehicle 30W” is one example of the “first mobile body”.

In the work support system 1 according to the present embodiment, the management server 50 manages a state of the user who executes predetermined work at the office vehicle 30W. For example, the management server 50 acquires biological information indicating the state of the user from the user who is executing work, and judges a degree of fatigue of the user who is executing the work on the basis of the biological information. Such judgement of the degree of fatigue while the user is executing the work can be, for example, recognized or inferred by the learning machine 60 which cooperates with the management server 50.

For example, the learning machine 60 is an information processing apparatus which has a neural network having a plurality of layers and which executes deep learning. The learning machine 60 executes inference processing, recognition processing, or the like, upon request from the management server 50. For example, the learning machine 60 executes convolution processing of receiving input of a parameter sequence {xi, i=1, 2, . . . , N} and performing product-sum operation on the input parameter sequence with a weighting coefficient (wi, j, l, (here, j is a value between 1 and an element count M to be subjected to convolution operation, and l is a value between 1 and the number of layers L)) and pooling processing which is processing of decimating part from an activating function for determining a result of the convolution processing and a determination result of the activating function for the convolution processing. The learning machine 60 repeatedly executes the processing described above over a plurality of layers L and outputs an output parameter (or an output parameter sequence) {yk, k=1, . . . , P} at a fully connected layer in a final stage. In this case, the input parameter sequence {xi} is, for example, a pixel sequence which is one frame of an image, a data sequence indicating a speech signal, a string of words included in natural language, or the like. Further, the output parameter (or the output parameter sequence) {yk} is, for example, a characteristic portion of an image which is an input parameter, a defect in the image, a classification result of the image, a characteristic portion in speech data, a classification result of speech, an estimation result obtained from a string of words, or the like.

The learning machine 60 receives input of a number of combinations of existing input parameter sequences and correct output values (training data) and executes learning processing in supervised learning. Further, the learning machine 60, for example, executes processing of clustering or abstracting the input parameter sequence in unsupervised learning. In learning processing, coefficients {wi, j, l} in the respective layers are adjusted so that a result obtained by executing convolution processing (and output by an activating function) in each layer, pooling processing and processing in the fully connected layer on the existing input parameter sequence approaches a correct output value. Adjustment of the coefficients {wi, j, l} in the respective layers is executed by letting an error based on a difference between output in the fully connected layer and the correct output value propagate from an upper layer to a lower input layer. Then, by inputting an unknown input parameter sequence {xi} in a state where the coefficients {wi, j, l} in the respective layers are adjusted, the learning machine 60 outputs a recognition result, a determination result, a classification result, an inference result, or the like, for the unknown input parameter sequence {xi}.

For example, the learning machine 60 extracts a face portion of the user from an image frame acquired by the office vehicle 30W. Further, the learning machine 60 recognizes speech of the user from speech data acquired by the office vehicle 30W and accepts a command by the speech. Further, the learning machine 60 determines the state of the user who is executing the work from an image of the face of the user to generate state information. The state information generated by the learning machine 60 is, for example, classification for classifying behavior (such as, for example, frequency and an interval of yawning, and a size of a pupil) for determining fatigue based on an image of a face portion of the user. As such classification, for example, a state is classified into evaluation values in four stages such that a favorable state for executing work is classified as “4”, a slightly favorable state is classified as “3”, a slightly fatigued state is classified as “2” and a fatigued state is classified as “1”. The image may be, for example, one which indicates temperature distribution of a face surface obtained from an infrared camera. The learning machine 60 reports the determined state information of the user to the management server 50, and the management server 50 judges that the user who is executing predetermined work is put into a state where the user needs a break on the basis of the reported state information. The management server 50 then provides service for a break for allowing the user to get refreshed and alleviating fatigue accumulated during execution of work to the user who is judged to be in a state where the user needs a break. Note that, in the present embodiment, learning executed by the learning machine 60 is not limited to machine learning by deep learning, and the learning machine 60 may execute learning by typical perceptron, learning by other neural networks, search using genetic algorithm, or the like, statistical processing, or the like. However, the management server 50 may determine the state of the user in accordance with the number of times of interruption of work, the number of times of yawning, frequency of the size of the pupil exceeding a predetermined size, and frequency of a period while the eyelid is closed exceeding a predetermined time period, from the image of the face of the user.

As a form of the service for a break, the management server 50, for example, adjusts an environment within the office vehicle during a break to an environment state which is different from that upon execution of work and which enables the user to get refreshed. Here, the environment refers to physical, chemical or biological conditions which are felt by the user through five senses and which affect a living body of the user. Examples of the environment can include, for example, brightness of lighting, and dimming within the office vehicle, daylighting from outside, view from the office vehicle, a temperature, humidity, and an air volume of air conditioning within the office vehicle, tilt of a chair within the office vehicle, and the like. The management server 50 can provide service for a break, for example, adjusting an environment within a car in accordance with preference of the user by adjusting the environment state within the office vehicle in accordance with the request from the user.

Further, as another form of the service for a break, the management server 50 may provide service of distributing acoustic data such as sound and music, image data, news, or the like, in accordance with the request from the user. The acoustic data includes classic, ambient music such as healing, music such as pops, sound such as chirrup of a bird, murmur of a stream, and sound of waves lapping against a sand beach, and a speech message registered in advance (for example, a message from a family member). The image data includes a moving image in accordance with the season such as floating of petals of cherry blossoms and autumn color of leaves, an image of shot landscape of a mountain, a river, a lake, the moon, or the like, a recorded image which is impressive for the user (for example, a scene in which a player who the user cheers for did well in the Olympic), a moving image registered in advance (for example, a scene in which a child of the user is playing), or the like. The management server 50 can provide the service for a break for allowing the user to get refreshed by providing the above-described distributed data selected in accordance with preference of the user via an in-vehicle display or acoustic equipment such as a speaker.

Further, as another form of the service for a break, the management server 50 may provide service such as tea service of providing light meal, tea, coffee, or the like, or service such as massage, sauna and shower in accordance with the request from the user. The above-described service is, for example, provided via the vehicle 30 which functions as a mobile type store (hereinafter, the vehicle 30 which functions as a store will be also referred to as a “store vehicle 30S”) directed to selling goods or providing service to the user. The store vehicle 30S includes, for example, facility, equipment, or the like, for operation of the store within the vehicle, and provides store service of the own vehicle to the user. The “store vehicle 30S” is one example of the “second mobile body”.

The management server 50, for example, selects the store vehicle 30S which provides tea service or store service such as massage, sauna and shower from the vehicles 30 constituting the mobile body system. For example, the management server 50 acquires location information, vehicle attribute information, or the like, from the store vehicle 30S. The management server 50 then selects the store vehicle 30S which is located around the office vehicle 30W and which provides tea service or store service such as massage, sauna and shower on the basis of the location information, the vehicle attribute information, or the like, from the store vehicle 30S. The management server 50 notifies the center server 20 of an instruction for causing the selected store vehicle to meet at a point where the office vehicle 30W is located. Here, meeting refers to dispatching the store vehicle 30S to the location of the office vehicle 30W and causing the store vehicle 30S to provide service in cooperation with the office vehicle 30W. An operation command for causing the store vehicle to meet at a point where the office vehicle 30W is located is issued via the center server 20 which cooperates with the management server 50.

When the center server 20 accepts a dispatch instruction from the management server 50, the center server 20 acquires location information of the store vehicle 30S to be dispatched and the office vehicle 30W which is a dispatch destination at the present moment. The center server 20 specifies a moving route in which, for example, a point where the store vehicle 30S is located is set as a starting point and the office vehicle 30W is set as a destination point after movement. The center server 20 then transmits an operation command indicating “moving from the starting point to the destination point” to the store vehicle 30S. By this means, the center server 20 can dispatch the store vehicle 30S by causing the store vehicle 30S to travel along a predetermined route from a current location to a destination which is a point where the office vehicle 30W is located, and provide service of the store vehicle to the user. Note that the operation command may include a command to the store vehicle 30S for providing service such as “temporarily dropping by a predetermined point (for example, the point where the office vehicle 30W is located)”, “letting the user get on or off the vehicle” and “providing tea service” to the user, in addition to the command for traveling.

The management server 50 can provide tea service of providing light meal, tea, coffee, or the like, or service such as massage, sauna and shower to the user via the store vehicle 30S. In the work support system 1 according to the present embodiment, it is possible to provide service for a break suitable for allowing the user to get refreshed and alleviating fatigue in accordance with preference of the user. As a result, in the work support system 1 according to the present embodiment, it is possible to provide a support technique which enables the user to appropriately execute predetermined work within the mobile body.

<2. Equipment Configuration>

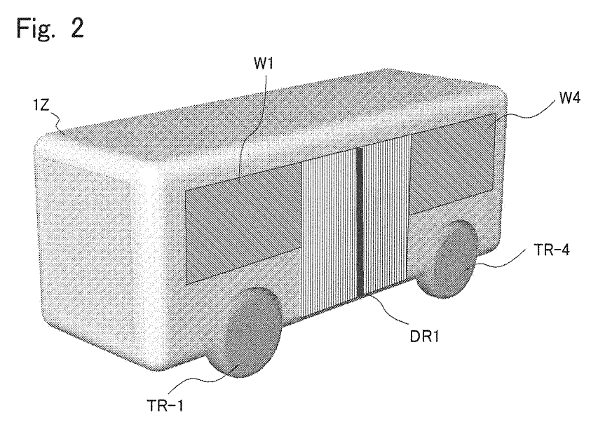

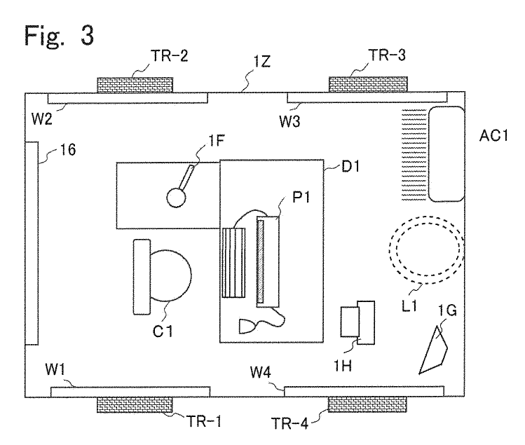

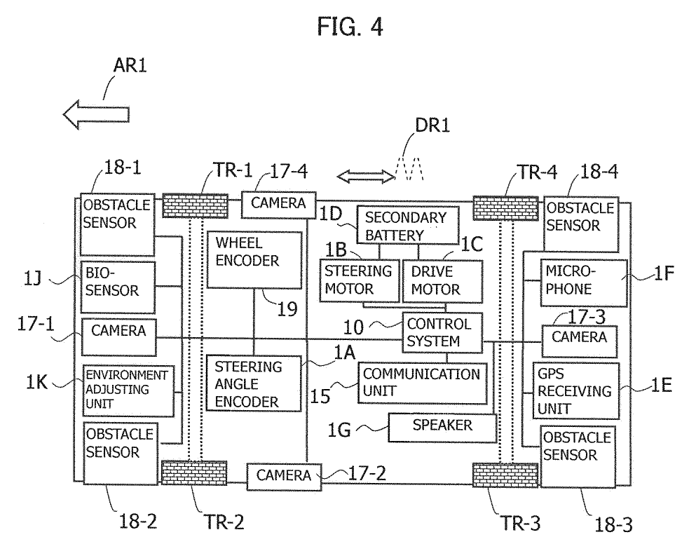

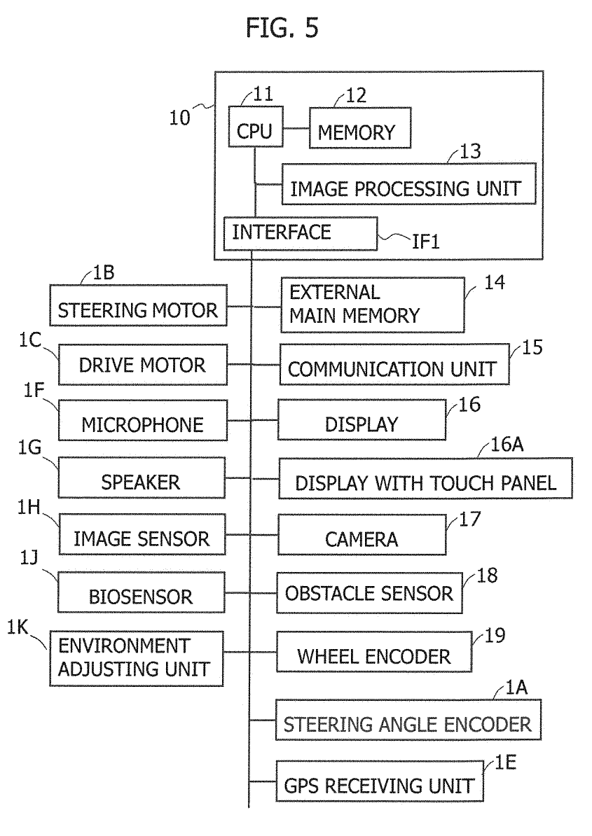

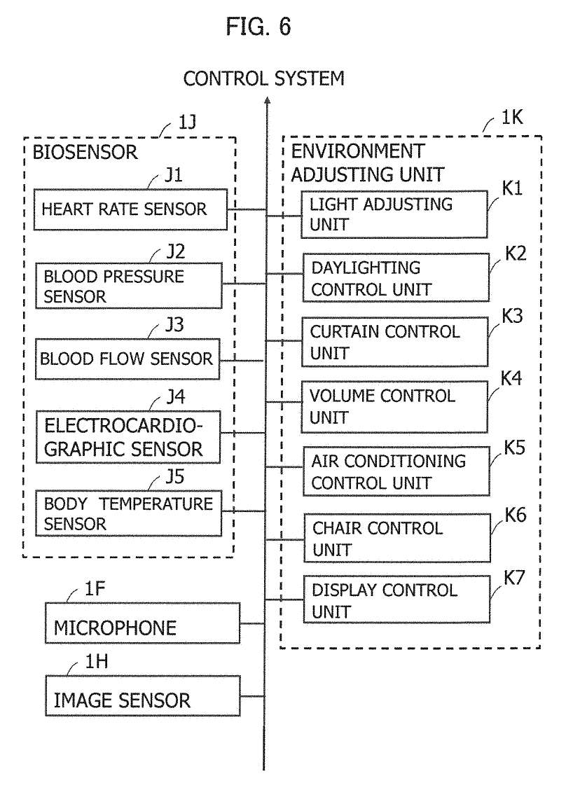

FIG. 2 is a perspective view illustrating appearance of the office vehicle 30W. FIG. 3 is a schematic plan view (view of in-vehicle space seen from a ceiling side of the office vehicle 30W) illustrating a configuration of the in-vehicle space of the office vehicle 30W. FIG. 4 is a diagram illustrating a plan view of arrangement of a sensor, a display, a drive apparatus and a control system mounted on the office vehicle 30W, seen from a lower side of the vehicle. FIG. 5 is a diagram illustrating a hardware configuration of the control system 10 mounted on the office vehicle 30W and each unit relating to the control system 10. FIG. 6 is a diagram illustrating detailed configurations of a biosensor 1J and an environment adjusting unit 1K mounted on the office vehicle 30W. FIG. 2 to FIG. 6 are one example of a form in which the EV palette which has been already described is employed as the office vehicle 30W. In FIG. 2 to FIG. 6, the office vehicle 30W is described as the EV palette.

The EV palette includes a boxlike body 1Z, and four wheels TR-1 to TR-4 provided at anterior and posterior portions in a traveling direction at both sides of a lower part of the body 1Z. The four wheels TR-1 to TR-4 are coupled to a drive shaft which is not illustrated and are driven by a drive motor 1C illustrated in FIG. 4. Further, the traveling direction upon traveling of the four wheels TR-1 to TR-4 (a direction parallel to a plane of rotation of the four wheels TR-1 to TR-4) is displaced relatively with respect to the body 1Z by a steering motor 1B illustrated in FIG. 4, so that the traveling direction is controlled.

As illustrated in FIG. 3, the EV palette which functions as a mobile type office provides predetermined facility for allowing the user to execute predetermined work within in-vehicle space. For example, the EV palette includes a desk D1, a chair C1, a personal computer P1, a microphone 1F, a speaker 1G, a display 16, an image sensor 1H, an air conditioner AC1 and a ceiling light L1 in internal space. Further, the EV palette has windows W1 to W4 at the boxlike body 1Z. The user who is on board the EV palette can, for example, do office work by utilizing in-vehicle space in which predetermined facility is disposed during movement of the EV palette. For example, the user sits on the chair C1 and performs document creation, transmission and reception of information with outside, or the like, using the personal computer P1 on the desk D1.

In the present embodiment, the EV palette adjusts an environment state of the in-vehicle space in accordance with a control instruction notified from the management server 50. For example, the chair C1 has an actuator which adjusts a height of a seating surface and tilt of a back. The EV palette varies the height of the seating surface and the tilt of the back of the chair C1 in accordance with the control instruction. Further, the windows W1 to W4 respectively have actuators which drive opening and closing of curtains or window shades. The EV palette adjusts daylighting from outside the vehicle and view of the outside the vehicle by adjusting opening of a window shade, or the like, in accordance with the control instruction. Further, the EV palette adjusts dimming of the ceiling light L1 which is in-vehicle lighting and a temperature, humidity, an air volume, or the like, of the in-vehicle space by the air conditioner AC1 in accordance with the control instruction. At the EV palette, the environment state of the in-vehicle space which functions as the mobile type office is adjusted to an environment state which is suitable for allowing the user to get refreshed and alleviating fatigue.

Further, the EV palette of the present embodiment acquires speech, an image and biological information of the user with the microphone 1F, the image sensor 1H and the biosensor 1J illustrated in FIG. 4, and transmits the speech, the image and the biological information to the management server 50. The management server 50, for example, judges whether the user who is executing work is put into a state where the user needs a break on the basis of the speech, the image and the biological information of the user transmitted from the EV palette. Further, the management server 50 distributes acoustic data, image data, news, or the like, selected in accordance with preference of the user to the EV palette on the basis of the speech, or the like, of the user. The acoustic data, the image data, the news, or the like, distributed from the management server 50 are output to the display 16 and the speaker 1G provided within a car of the EV palette. At the EV palette, the acoustic data, the image data, the news, or the like, in accordance with preference of the user are provided. Further, the management server 50 causes the store vehicle 30S which provides tea service, massage service, and service such as sauna and shower to be dispatched to the EV palette on the basis of the speech, or the like, of the user. At the EV palette, various kinds of service provided by the store vehicle 30S dispatched in accordance with preference of the user can be utilized.

It is assumed in FIG. 4 that the EV palette travels in a direction of an arrow AR1. Therefore, it is assumed that a left direction in FIG. 4 is a traveling direction. Therefore, in FIG. 4, a side surface on the traveling direction side of the body 1Z is referred to as a front surface of the EV palette, and a side surface in a direction opposite to the traveling direction is referred to as a back surface of the EV palette. Further, a side surface on a right side of the traveling direction of the body 1Z is referred to as a right side surface, and a side surface on a left side is referred to as a left side surface.

As illustrated in FIG. 4, the EV palette has obstacle sensors 18-1 and 18-2 at locations close to corner portions on both sides on the front surface, and has obstacle sensors 18-3 and 18-4 at locations close to corner portions on both sides on the back surface. Further, the EV palette has cameras 17-1, 17-2, 17-3 and 17-4 respectively on the front surface, the left side surface, the back surface and the right side surface. In the case where the obstacle sensors 18-1, or the like, are referred to without distinction, they will be collectively referred to as an obstacle sensor 18 in the present embodiment. Further, in the case where the cameras 17-1, 17-2, 17-3 and 17-4 are referred to without distinction, they will be collectively referred to as a camera 17 in the present embodiment.

Further, the EV palette includes the steering motor 1B, the drive motor 1C, and a secondary battery 1D which supplies power to the steering motor 1B and the drive motor 1C. Further, the EV palette includes a wheel encoder 19 which detects a rotation angle of the wheel each second, and a steering angle encoder 1A which detects a steering angle which is the traveling direction of the wheel. Still further, the EV palette includes the control system 10, a communication unit 15, a GPS receiving unit 1E, a microphone 1F and a speaker 1G. Note that, while not illustrated, the secondary battery 1D supplies power also to the control system 10, or the like. However, a power supply which supplies power to the control system 10, or the like, may be provided separately from the secondary battery 1D which supplies power to the steering motor 1B and the drive motor 1C.

The control system 10 is also referred to as an Electronic Control Unit (ECU). As illustrated in FIG. 5, the control system 10 includes a CPU 11, a memory 12, an image processing unit 13 and an interface IF1. To the interface IF1, an external storage device 14, the communication unit 15, the display 16, a display with a touch panel 16A, the camera 17, the obstacle sensor 18, the wheel encoder 19, the steering angle encoder 1A, the steering motor 1B, the drive motor 1C, the GPS receiving unit 1E, the microphone 1F, the speaker 1G, an image sensor 1H, a biosensor 1J, an environment adjusting unit 1K, or the like, are connected.

The obstacle sensor 18 is an ultrasonic sensor, a radar, or the like. The obstacle sensor 18 emits an ultrasonic wave, an electromagnetic wave, or the like, in a detection target direction, and detects existence, a location, relative speed, or the like, of an obstacle in the detection target direction on the basis of a reflected wave.

The camera 17 is an imaging apparatus using an image sensor such as Charged-Coupled Devices (CCD), a Metal-Oxide-Semiconductor (MOS), or a Complementary Metal-Oxide-Semiconductor (CMDS). The camera 17 acquires an image at predetermined time intervals called a frame period, and stores the image in a frame buffer which is not illustrated, within the control system 10. An image stored in the frame buffer with a frame period is referred to as frame data.

The steering motor 1B controls a direction of a cross line on which a plane of rotation of the wheel intersects with a horizontal plane, that is, an angle which becomes a traveling direction by rotation of the wheel, in accordance with an instruction signal from the control system 10. The drive motor 1C, for example, drives and rotates the wheels TR-1 to TR-4 in accordance with the instruction signal from the control system 10. However, the drive motor 1C may drive one pair of wheels TR-1 and TR-2 or the other pair of wheels TR-3 and TR-4 among the wheels TR-1 to TR-4. The secondary battery 1D supplies power to the steering motor 1B, the drive motor 1C and parts connected to the control system 10.

The steering angle encoder 1A detects a direction of the cross line on which the plane of rotation of the wheel intersects with the horizontal plane (or an angle of the rotating shaft of the wheel within the horizontal plane), which becomes the traveling direction by rotation of the wheel, at predetermined detection time intervals, and stores the direction in a register which is not illustrated, in the control system 10. In this case, for example, a direction to which the rotating shaft of the wheel is orthogonal with respect to the traveling direction (direction of the arrow AR1) in FIG. 4 is set as an origin of the traveling direction (angle). However, setting of the origin is not limited, and the traveling direction (the direction of the arrow AR1) in FIG. 4 may be set as the origin. Further, the wheel encoder 19 acquires rotation speed of the wheel at predetermined detection time intervals, and stores the rotation speed in a register which is not illustrated, in the control system 10.

The communication unit 15 is a communication unit for communicating with, for example, various kinds of servers, or the like, on a network N1 through a mobile phone base station and a public communication network connected to the mobile phone base station. The communication unit 15 performs wireless communication with a wireless signal and a wireless communication scheme in accordance with predetermined wireless communication standards.

The Global Positioning System (GPS) receiving unit 1E receives radio waves of time signals from a plurality of satellites (Global Positioning Satellites) which orbit the earth and stores the radio waves in a register which is not illustrated, in the control system 10. The microphone 1F detects sound or speech (also referred to as acoustic), converts the sound or speech into a digital signal and stores the digital signal in a register which is not illustrated, in the control system 10. The speaker 1G is driven by a D/A converter and an amplifier connected to the control system 10 or a signal processing unit which is not illustrated, and reproduces acoustic including sound and speech.

The CPU 11 of the control system 10 executes a computer program expanded at the memory 12 so as to be able to be executed, and executes processing as the control system 10. The memory 12 stores a computer program to be executed by the CPU 11, data to be processed by the CPU 11, or the like. The memory 12 is, for example, a Dynamic Random Access Memory (DRAM), a Static Random Access Memory (SRAM), a Read Only Memory (ROM), or the like. The image processing unit 13 processes data in the frame buffer obtained for each predetermined frame period from the camera 17 in cooperation with the CPU 11. The image processing unit 13, for example, includes a Graphics Processing Unit (GPU) and an image memory which becomes the frame buffer. The external storage device 14, which is a non-volatile storage device, is, for example, a Solid State Drive (SSD), a hard disk drive, or the like.

For example, as illustrated in FIG. 5, the control system 10 acquires a detection signal from a sensor of each unit of the EV palette via the interface IF1. Further, the control system 10 calculates latitude and longitude which is a location on the earth from the detection signal from the GPS receiving unit 1E. Still further, the control system 10 acquires map data from a map information database stored in the external storage device 14, matches the calculated latitude and longitude to a location on the map data and determines a current location. Further, the control system 10 acquires a route to a destination from the current location on the map data. Still further, the control system 10 detects an obstacle around the EV palette on the basis of signals from the obstacle sensor 18, the camera 17, or the like, determines the traveling direction so as to avoid the obstacle and controls the steering angle.

Further, the control system 10 processes images acquired from the camera 17 for each frame data in cooperation with the image processing unit 13, for example, detects change based on a difference in images and recognizes an obstacle. Further, the control system 10 analyzes a speech signal obtained from the microphone 1F and responds to intention of the user obtained through speech recognition. Note that the control system 10 may transmit frame data of an image from the camera 17 and speech data obtained from the microphone 1F from the communication unit 15 to the center server 20 and the management server 50 on the network. Then, it is also possible to cause the center server 20 and the management server 50 to share analysis of the frame data of the image and the speech data.

Still further, the control system 10 displays an image, characters and other information on the display 16. Further, the control system 10 detects operation to the display with the touch panel 16A and accepts an instruction from the user. Further, the control system 10 responds to the instruction from the user via the display with the touch panel 16A, the camera 17 and the microphone 1F, from the display 16, the display with the touch panel 16A or the speaker 1G.

Further, the control system 10 acquires a face image of the user in the indoor space from the image sensor 1H and notifies the management server 50. The image sensor 1H is an imaging apparatus by the image sensor as with the camera 17. However, the image sensor 1H may be an infrared camera. Further, the control system 10 acquires the biological information of the user via the biosensor 1J and notifies the management server 50. Further, the control system 10 adjusts the environment of the indoor space via the environment adjusting unit 1K in accordance with the control instruction notified from the management server 50. Further, the control system 10 outputs the acoustic data, the image data, the news, or the like, distributed from the management server 50 to the display 16 and the speaker 1G via the environment adjusting unit 1K.

While the interface IF1 is illustrated in FIG. 5, a path for transmission and reception of signals between the control system 10 and a control target is not limited to the interface IF1. That is, the control system 10 may have a plurality of signal transmission and reception paths other than the interface IF1. Further, in FIG. 5, the control system 10 has a single CPU 11. However, the CPU is not limited to a single processor and may employ a multiprocessor configuration. Further, a single CPU connected with a single socket may employ a multicore configuration. Processing of at least part of the above-described units may be executed by processors other than the CPU, for example, at a dedicated processor such as a Digital Signal Processor (DSP) and a Graphics Processing Unit (GPU). Further, at least part of processing of the above-described units may be an integrated circuit (IC) or other digital circuits. Still further, at least part of the above-described units may include analog circuits.

FIG. 6 illustrates the microphone 1F and the image sensor 1H as well as the biosensor 1J and the environment adjusting unit 1K. The control system 10 acquires information relating to the condition of the user who is executing work from the microphone 1F, the image sensor 1H and the biosensor 1J and notifies the management server 50.

As illustrated in FIG. 6, the biosensor 1J includes at least one of a heart rate sensor J1, a blood pressure sensor J2, a blood flow sensor J3, an electrocardiographic sensor J4 and a body temperature sensor J5. That is, the biosensor 1J is a combination of one or a plurality of these sensors. However, the biosensor 1J of the present embodiment is not limited to the configuration in FIG. 6. In the present work support system 1, in the case where a function of providing predetermined service for a break is utilized, the microphone 1F acquires speech of the user, or the image sensor 1H acquires the image of the user. Further, the user may wear the biosensor 1J on the body of the user himself/herself.

The heart rate sensor J1, which is also referred to as a heart rate meter or a pulse wave sensor, irradiates blood vessels of the human body with a Light Emitting Diode (LED), and specifies a heart rate from change of the blood flow with the reflected light. The heart rate sensor J1 is, for example, worn on the body such as the wrist of the user. Note that the blood flow sensor J3 has a light source (laser) and a light receiving unit (photodiode) and measures a blood flow rate on the basis of Doppler shift from scattering light from moving hemoglobin. Therefore, the heart rate sensor J1 and the blood flow sensor J3 can share a detecting unit.

The blood pressure sensor J2 has a compression garment (cuff) which performs compression by air being pumped after the compression garment is wound around the upper arm, a pump which pumps air to the cuff, and a pressure sensor which measures a pressure of the cuff, and determines a blood pressure on the basis of fluctuation of the pressure of the cuff which is in synchronization with heart beat of the heart in a depressurization stage after the cuff is compressed once (oscillometric method). However, the blood pressure sensor J2 may be one which shares a detecting unit with the above-described heart rate sensor J1 and blood flow sensor J3 and which has a signal processing unit that converts the change of the blood flow detected at the detecting unit into a blood pressure.

The electrocardiographic sensor J4 has an electrode and an amplifier, and acquires an electrical signal generated from the heart by being worn on the breast. The body temperature sensor J5, which is a so-called electronic thermometer, measures a body temperature in a state where the body temperature sensor J5 contacts with a body surface of the user. However, the body temperature sensor J5 may be infrared thermography. That is, the body temperature sensor J5 may be one which collects infrared light emitted from the face, or the like, of the user, and measures a temperature on the basis of luminance of the infrared light radiated from a surface of the face.

The environment adjusting unit 1K includes at least one of a light adjusting unit K1, a daylighting control unit K2, a curtain control unit K3, a volume control unit K4, an air conditioning control unit K5, a chair control unit K6 and a display control unit K7. That is, the environment adjusting unit 1K is a combination of one or a plurality of these control units. However, the environment adjusting unit 1K of the present embodiment is not limited to the configuration in FIG. 6. The environment adjusting unit 1K controls each unit within the EV palette in accordance with the control instruction notified from the management server 50 and adjusts the environment state of the in-vehicle space which functions as the mobile type office to a state appropriate for a break.

The light adjusting unit K1 controls the LED built in the ceiling light L1 in accordance with a light amount designated value and a light wavelength component designated value included in the control instruction and adjusts a light amount and a wavelength component of light emitted from the ceiling light L1. The daylighting control unit K2 instructs the actuators of the window shades provided at the windows W1 to W4 and adjusts daylighting and view from the windows W1 to W4 in accordance with a daylighting designated value included in the control instruction. Here, the daylighting designated value is, for example, a value designating an opening (from fully opened to closed) of the window shade. In a similar manner, the curtain control unit K3 instructs the actuators of the curtains provided at the windows W1 to W4 and adjusts opened/closed states of the curtains at the windows W1 to W4 in accordance with an opening designated value for the curtain included in the control instruction. Here, the opening designated value is, for example, a value designating an opening (fully opened to closed) of the curtain.

The volume control unit K4 adjusts sound quality and a volume of sound output by the control system 10 from the speaker 1G in accordance with a sound designated value included in the control instruction. Here, the sound designated value is, for example, whether or not a high frequency or a low frequency is emphasized, a degree of emphasis, a degree of an echo effect, a volume maximum value, a volume minimum value, or the like.

The air conditioning control unit K5 adjusts an air volume and air direction from the air conditioner AC1 and a set temperature in accordance with an air conditioning designated value included in the control instruction. Further, the air conditioning control unit K5 controls ON or OFF of a dehumidification function at the air conditioner AC1 in accordance with the control instruction. The chair control unit K6 instructs the actuator of the chair C1 to adjust a height of the seating surface and tilt of the back of the chair C1 in accordance with the control instruction. The display control unit K7 reproduces the distributed acoustic data, image data, news, or the like, and outputs the acoustic data, the image data, the news, or the like, to the display 16 and the speaker 1G.

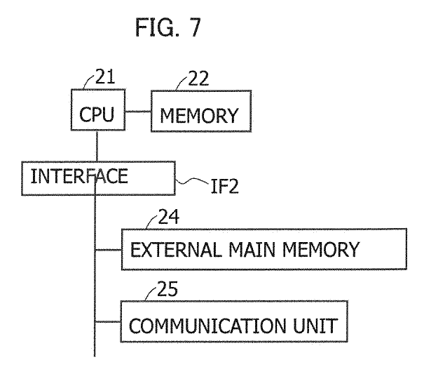

FIG. 7 is a diagram illustrating a hardware configuration of the center server 20. The center server 20 includes a CPU 21, a memory 22, an interface IF2, an external storage device 24, and a communication unit 25. The configurations and operation of the CPU 21, the memory 22, the interface IF2, the external storage device 24 and the communication unit 25 are similar to those of the CPU 11, the memory 12, the interface IF1, the external storage device 14 and the communication unit 15 in FIG. 5. Further, the configuration of the management server 50 and the user terminal 40 is also similar to that of the center server 20 in FIG. 7. However, the user terminal 40 may include, for example, a touch panel as an input unit which accepts user operation. Further, the user terminal 40 may include a display and a speaker as an output unit for providing information to the user.

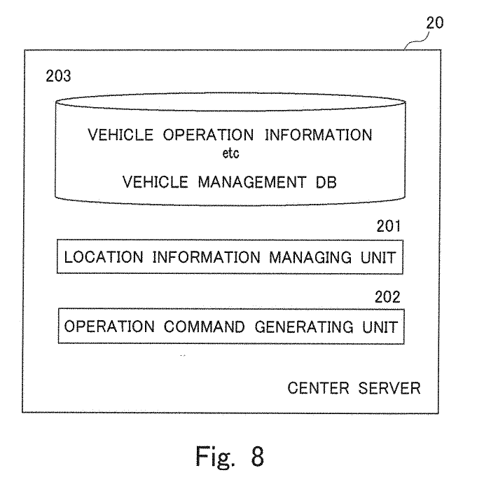

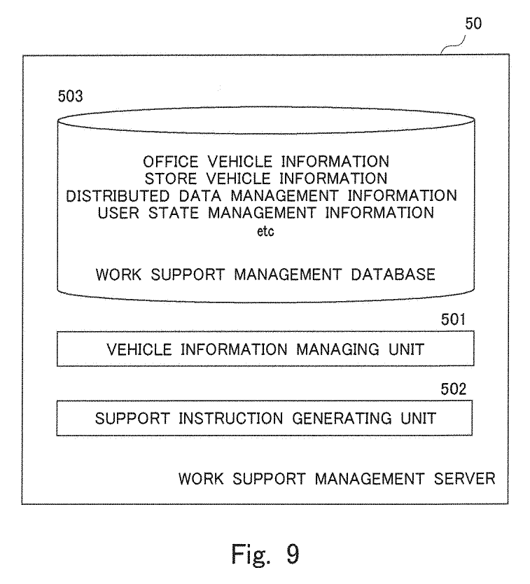

Functional configurations of the center server 20 and the management server 50 in the work support system 1 will be described next using FIG. 8 and FIG. 9. FIG. 8 is a diagram illustrating an example of the functional configuration of the center server 20. FIG. 9 is a diagram illustrating an example of the functional configuration of the management server 50. The center server 20 operates as each unit illustrated in FIG. 8 by a computer program on a memory. That is, the center server 20 includes a location information managing unit 201, an operation command generating unit 202, and a vehicle management DB 203 as functional components. In a similar manner, the management server 50 operates by a computer program on a memory and includes a vehicle information managing unit 501, a support instruction generating unit 502, and a work support management database (DB) 503 illustrated in FIG. 9 as functional components. Note that one of the functional components or part of the processing of the center server 20 and the management server 50 may be executed by other computers connected to the network N. Further, while it is possible to cause hardware to execute a series of processing to be executed at the center server 20 and the management server 50, it is also possible to cause software to execute the series of processing.

In FIG. 8, the location information managing unit 201, for example, receives location information transmitted from each vehicle under management of the center server 20 with a predetermined period, and stores the location information in the vehicle management DB 203 which will be described later.

The operation command generating unit 202 issues a command of an operation route and estimated time of arrival at a destination to the office vehicle 30W in accordance with the operation plan of the office vehicle 30W. Further, in response to a notification of the vehicle attribute information of a vehicle to be dispatched from the management server 50 with which the vehicle is to cooperate, the operation command generating unit 202 generates an operation command for the vehicle. The notification of the vehicle to be dispatched from the management server 50 includes information of the office vehicle 30W which is a dispatch destination, and the store vehicle 30S which can provide predetermined service to a user who is on board the office vehicle. The operation command generating unit 202 acquires location information of the office vehicle 30W and the store vehicle 30S at the present moment. The operation command generating unit 202 then specifies a moving route in which a point where the store vehicle 30S is located at the present moment is set as a starting point, and a point where the office vehicle 30W is located is set as a destination, for example, with reference to map data stored in an external storage device, or the like. The operation command generating unit 202 then generates an operation command to the destination from the vehicle location at the present moment for the store vehicle 30S. Note that the operation command includes instructions, or the like, such as “temporarily dropping by”, “letting the user get on or off the vehicle” and “providing tea service” for the user who utilizes the store vehicle 30S at the destination.

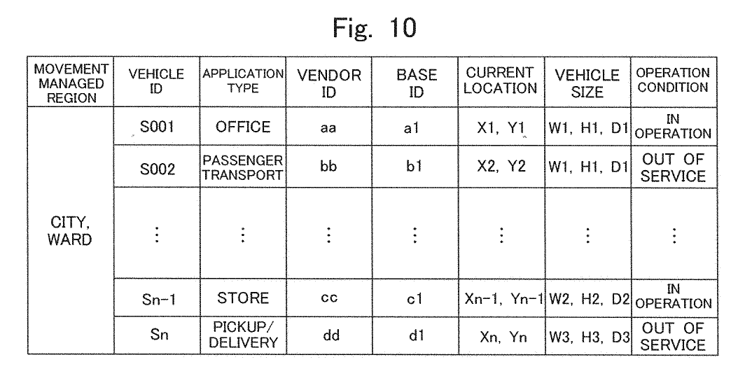

In the vehicle management DB 203, vehicle operation information regarding the plurality of vehicles 30 which autonomously travel is stored. FIG. 10 is a diagram explaining vehicle operation information in a table configuration. As illustrated in FIG. 10, the vehicle operation information has respective fields of a movement managed region, a vehicle ID, an application type, a vendor ID, a base ID, a current location, a vehicle size and an operation condition. In the movement managed region, information for specifying a movement region in which each vehicle provides service is stored. The movement managed region may be information indicating a city, a ward, a town, a village, or the like, or may be information specifying a region sectioned with latitude and longitude. In the vehicle ID, identification information for uniquely identifying the vehicle 30 managed by the center server 20 is stored. In the application type, information specifying an application type of service to be provided by each vehicle is stored. For the vehicle 30 which functions as a mobile type office, “office” is stored, for the vehicle 30 which is directed to selling goods or providing service, “store” is stored, for the vehicle 30 which provides movement service to the user, “passenger transport” is stored, and, for the vehicle 30 which provides pickup/delivery service of baggage, or the like, to the user, “pickup/delivery” is stored. In the vendor ID, identification information uniquely identifying a vendor which provides the above-described service using the vehicle 30 is stored. The vendor ID is typically a business operator code allocated to the vendor. In the base ID, identification information identifying a location which becomes a base of the vehicle 30 is stored. The vehicle 30 starts from a base location identified by the base ID and returns to the base location after provision of service in the movement managed region is finished. In the current location, location information (latitude, longitude) acquired from each vehicle 30 is stored. The location information is updated when location information transmitted from each vehicle 30 is received. The vehicle size is information indicating a size (a width (W), a height (H), a depth (D)) of the store vehicle. In the operation condition, status information indicating an operation condition of the vehicle 30 is stored. For example, in the case where the vehicle is providing service by autonomously traveling, “in operation” is stored, and in the case where the service is not being provided, “out of service” is stored.

The management server 50 will be described next using FIG. 9. The vehicle information managing unit 501 acquires vehicle attribute information transmitted from each vehicle constituting the mobile body system with a predetermined period and stores the vehicle attribute information in a work support management DB 503 which will be described later. Here, the vehicle attribute information includes a user ID, reservation time, and work schedule, of the user who utilizes the vehicle 30 which functions as the office vehicle 30W, and mounted facility provided at the office vehicle 30W. Further, the vehicle attribute information includes store name, a service type, a line of goods, a vendor ID and opening hours, of the store vehicle 30S which functions as a store. Each vehicle which constitutes the mobile body system transmits the location information and the vehicle attribute information along with the vehicle ID of the own vehicle.

The support instruction generating unit 502 collects biological information of the user transmitted from the vehicle 30 which functions as the office vehicle 30W with a predetermined period, and accumulates the biological information in the work support management DB 503 which will be described later as user state management information. The biological information of the user is, for example, measured with the biosensor 1J over a certain period of time at intervals of a predetermined period. The support instruction generating unit 502 accumulates the biological information measured with the biosensor 1J in the work support management DB 503 and hands over the measured biological information to the learning machine 60 which cooperates with the management server 50. The learning machine 60 reports the state information indicating the state of the user who is executing work to the management server 50 on the basis of the biological information which is handed over. The management server 50 stores the state information reported from the learning machine 60 in the user state management information and judges that the user who is executing predetermined work is put into a state where the user needs a break on the basis of the state information.

The support instruction generating unit 502, for example, encourages the user who is executing work within the office vehicle 30W to notice concerning a break. The support instruction generating unit 502 makes a recommendation for encouraging the user to temporarily stop work which is being executed and have a break to the user via, for example, a speech message or a display message. The support instruction generating unit 502 then presents menu of service for a break which can be provided at the office vehicle 30W. The menu is, for example, displayed as a display screen of a display with a touch panel 16A.

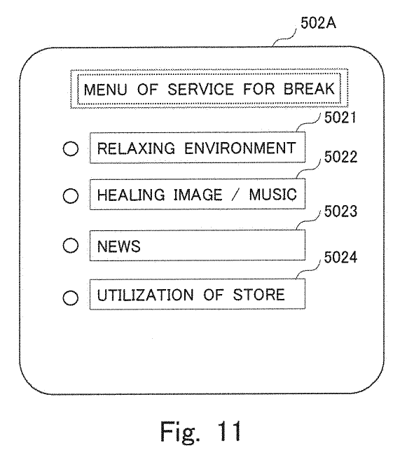

FIG. 11 is a diagram illustrating an example of a display screen to be displayed on the display with the touch panel 16A. As indicated in a display screen 502A in FIG. 11, a list of service for a break which can be provided at the office vehicle 30W is presented as menu. In FIG. 11, items such as a “relaxing environment (5021)” for adjusting an environment state within the office vehicle 30W, “healing image/music (5022)” for listening to acoustic data or watching image data, “news (5023)” for watching image of a news and listening to speech of a news, and “utilization of store (5024)” for utilizing the store vehicle 30S which provides tea, massage, sauna, shower, or the like, are presented.

When the support instruction generating unit 502, for example, accepts selection operation of the “relaxing environment (5021)”, the support instruction generating unit 502 further displays a list of environment adjustment service which can be provided in accordance with predetermined facility provided at the office vehicle 30W. The support instruction generating unit 502 then issues a control instruction to facility equipment selected from the list via the operation input to the display with the touch panel 16A or the microphone 1F. At the office vehicle 30W, the height of the seating surface and tilt of the back of the chair C1, daylighting from outside the car, view of outside of the car, dimming of lighting within the car, a temperature, humidity, or an air volume of the in-vehicle space by the air conditioner AC1, or the like, are adjusted in accordance with the control instruction.

Further, when the support instruction generating unit 502, for example, accepts selection operation of the “healing image/music (5022)”, the support instruction generating unit 502 further displays a distribution list of acoustic data and image data which can be provided via the display 16 and the speaker 1G. The support instruction generating unit 502 then distributes the acoustic data and the image data selected from the distribution list via operation input to the display with the touch panel 16A or the microphone IF. Various kinds of data distributed to the office vehicle 30W is, for example, reproduced via a volume control unit K4 and a display control unit K7 and output to the display 16 and the speaker 1G.

Processing in the case where the “news (5023)” is selected is similar to that in the case where the “healing image/music (5022)” is selected. The support instruction generating unit 502 displays a watch list of news images and speech which can be provided via the display 16 and the speaker 1G. The watch list includes a TV channel and a radio channel which provide news images and speech. The support instruction generating unit 502 distributes the news image and speech selected from the watch list via operation input to the display with the touch panel 16A or the microphone 1F.

Further, when the support instruction generating unit 502 accepts selection operation of the “utilization of store (5024)”, the support instruction generating unit 502 further displays a list of store service which can be provided to the user within the office vehicle. The support instruction generating unit 502 accepts service selected from the list of the store service via operation input to the display with the touch panel 16A or the microphone 1F. The support instruction generating unit 502 then generates a dispatch instruction of dispatching the store vehicle 30S which can provide the selected store service to the office vehicle 30W and notifies the center server 20 with which the vehicle cooperates of the dispatch instruction. The center server 20 generates an operation command to the store vehicle 30S on the basis of the accepted dispatch instruction from the management server 50.

The work support management DB 503 will be described next. As illustrated in FIG. 9, in the work support management DB 503, at least office vehicle information, store vehicle information, distributed data management information and user state management information are stored.

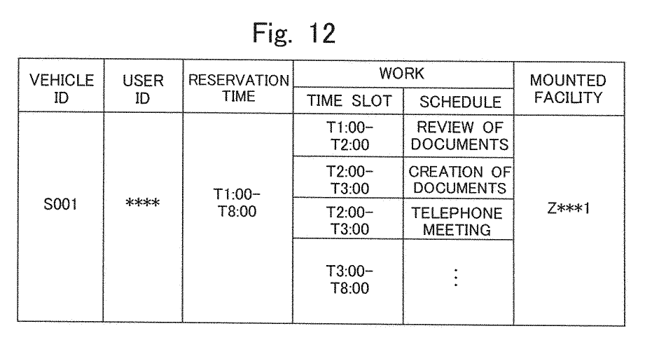

The office vehicle information is management information which manages vehicle attribute information for each vehicle which functions as the office vehicle 30W. FIG. 12 is a diagram explaining office vehicle information in a table configuration. As illustrated in FIG. 12, the office vehicle information includes respective fields of a vehicle ID, a user ID, reservation time, work, and mounted facility. The vehicle ID is a vehicle ID of the office vehicle 30W. The user ID is identification information uniquely identifying a user who utilizes the office vehicle. The user ID is, for example, provided by the center server 20 upon reservation of utilization of the office vehicle or upon start of utilization of the office vehicle. The reservation time is time at which the office vehicle is to be utilized. The reservation time is registered in the vehicle attribute information on the basis of user input when reservation of utilization of the office vehicle is accepted. The work is information indicating schedule of work to be executed within the office vehicle, and includes a time slot sub-field and a schedule sub-field. The work schedule is, for example, acquired from a schedule database in which schedule of the user is registered. The time slot sub-field is a time slot of the work schedule. The schedule sub-field is content of work schedule to be executed in the time slot. In FIG. 12, work content such as “review of documents”, “creation of documents” and a “telephone meeting” is illustrated. The mounted facility is information indicating a configuration of predetermined facility provided within the office vehicle. The configuration of the predetermined facility can be changed in accordance with work content.

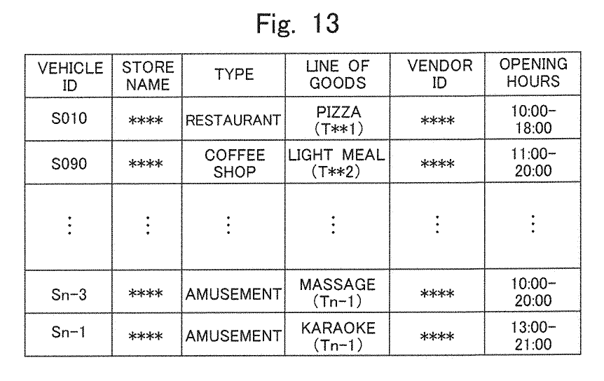

The store vehicle information is management information managing the vehicle attribute information for each vehicle which functions as the store vehicle 30S. FIG. 13 is a diagram explaining the store vehicle information in a table configuration. As illustrated in FIG. 13, the store vehicle information includes respective fields of a vehicle ID, store name, a type, a line of goods, a vendor ID and opening hours. The vehicle ID is a vehicle ID of the store vehicle 30S. The store name is name of the store vehicle. The type is a type of service to be provided by the store vehicle. For example, information is stored such that, in the case where food service of providing a pizza, a hamburger, soba, or the like, is provided to the user, a “restaurant” is stored, in the case where tea service of providing coffee and light meal such as a sandwich is provided, a “coffee shop” is stored, and, in the case where service for a break such as massage and karaoke is provided, “amusement” is stored. The line of goods is information of goods, or the like, dealt with at the store vehicle. The line of goods includes a table number indicating details of the line of goods transmitted from the store vehicle as the vehicle attribute information. The opening hours are information indicating time at which providing of goods/service of the store vehicle is started and ended.

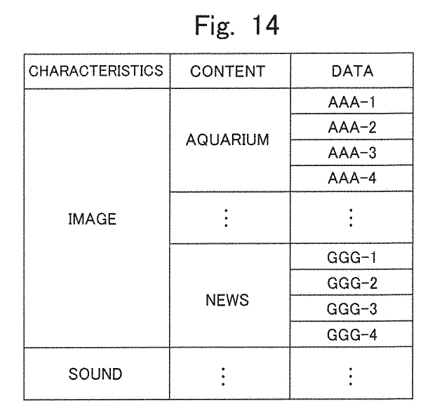

The distributed data management information is information managing image data, acoustic data, news, or the like, to be distributed while the user is on a break. FIG. 14 is a diagram explaining the distributed data management information in a table configuration. As illustrated in FIG. 14, the distributed data management information includes respective fields of characteristics, content and data. The characteristics are information indicating a form of distributed data. For example, in a case of the image data, an “image” is stored, and in a case of the acoustic data, “sound”, “music”, or the like, is stored. In the content, type information indicating content of the distributed data is stored. In FIG. 14, type information such as an “aquarium” and “news” indicating content of the image data is illustrated. The data is an identification number identifying the distributed data.

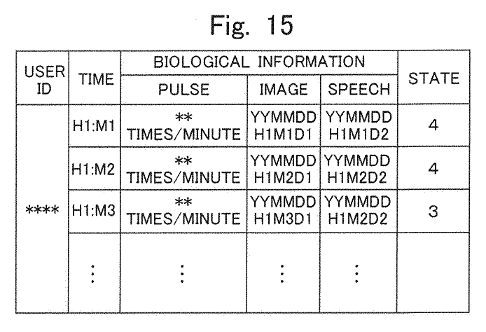

The user state management information is information managing a state of the user who utilizes the office vehicle 30W. The user state management information is managed for each user. In the user state management information, information regarding the state of the user who is executing work, acquired from the biosensor 1J, the microphone 1F and the image sensor 1H mounted on the office vehicle 30W is managed. FIG. 15 is a diagram explaining the user state management information in a table configuration. As illustrated in FIG. 15, the user state management information includes respective fields of a user ID, time, biological information and a state. The user ID is identification information uniquely identifying the user who utilizes the office vehicle. The time is information of time at which the biological information is acquired. The biological information is, for example, acquired over a certain period of time at intervals of a predetermined period. The biological information includes sub-fields for each sensor which acquires the state of the user. In FIG. 15, a pulse sub-field, an image sub-field and a speech sub-field are illustrated. In the pulse, a pulse rate per unit time (for example, a minute) measured at the biosensor 1J is stored. In the image, identification number identifying an image (picture) acquired at the image sensor 1H is stored. In the speech, identification number identifying a speech acquired at the microphone 1F is stored. In the state, state information indicating a state of the user who is executing work, estimated on the basis of the biological information is stored. The state information is, for example, estimated by the learning machine 60. In FIG. 15, the state information indicating the state of the user is stored as an evaluation value which is classified into four stages of “4”, “3”, “2” and “1”.

<3. Processing Flow>

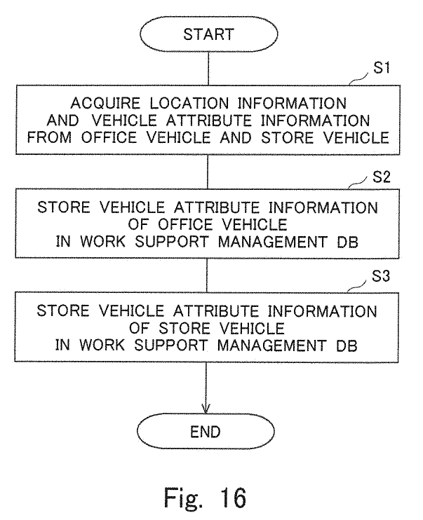

Processing relating to work support in the present embodiment will be described next with reference to FIG. 16 to FIG. 19. FIG. 16 is a flowchart illustrating an example of processing of managing the office vehicle 30W and the store vehicle 30S. The processing from FIG. 16 to FIG. 19 is regularly executed.

The processing in the flowchart in FIG. 16 is started, for example, when the location information and the vehicle attribute information transmitted from each vehicle are received. Each vehicle, for example, leaves each base managed in the vehicle management DB 203 of the center server 20 as the base ID and provides service of the own vehicle. Each vehicle transmits location information of the own vehicle acquired via a GPS receiving unit 1E to the center server 20 and the management server 50 connected to the network N. Further, the control system 10 of each vehicle reads out the vehicle attribute information registered in the external storage device 14, or the like, and transmits the vehicle attribute information to the management server 50 connected to the network N. Each vehicle transmits the location information and the vehicle attribute information along with the vehicle ID of the own vehicle.

The management server 50 acquires the location information and the vehicle attribute information transmitted from each of the office vehicle 30W and the store vehicle 30S (S1). The management server 50 stores the vehicle attribute information acquired from the office vehicle 30W in the office vehicle information of the work support management DB 503 in association with the vehicle ID (S2). The vehicle attribute information acquired from the office vehicle 30W includes a user ID, reservation time, and work schedule, of the user who utilizes the office vehicle 30W, and identification number of predetermined facility provided within a car to execute work. Further, the management server 50 stores the vehicle attribute information acquired from the store vehicle 30S in the store vehicle information of the work support management DB 503 in association with the vehicle ID (S3). The vehicle attribute information acquired from the store vehicle 30S includes a type of service to be provided by the store vehicle, a line of goods, opening hours, or the like. After the processing in S3, the processing illustrated in FIG. 16 is finished.

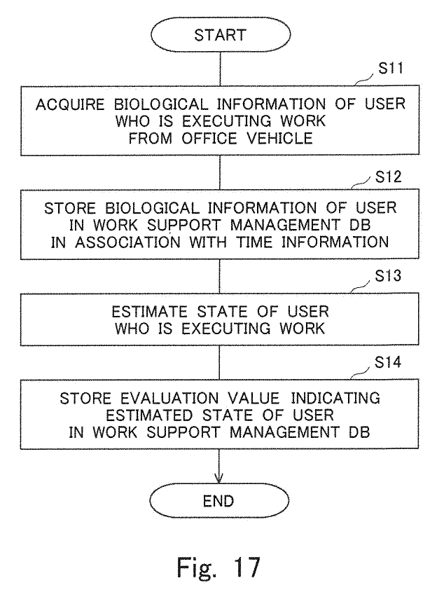

FIG. 17 will be described next. FIG. 17 is a flowchart illustrating an example of processing of managing the state of the user who is executing work. In an example in the flowchart in FIG. 17, the processing is started when the biological information of the user acquired via the biosensor 1J, the microphone 1F and the image sensor 1H is received from the office vehicle 30W. The biological information is, for example, acquired over a certain period of time at intervals of a predetermined period. The office vehicle 30W transmits the biological information to the management server 50 connected to the network N along with the vehicle ID of the own vehicle.

The management server 50 acquires the biological information of the user who is executing work, which is transmitted from the office vehicle 30W (S11). The management server 50 stores the acquired biological information in the user state management information of the work support management DB 503 in association with time information and the user ID (S12). The user ID is specified on the basis of the vehicle ID. The management server 50 then estimates the state of the user who is executing work on the basis of the acquired biological information (S13). The state of the user who is executing work is, for example, estimated by the learning machine 60 which cooperates with the management server 50. The learning machine 60, for example, estimates the state of the user at the present moment on the basis of tendency to exhibit a relatively favorable state (duration of a favorable state, a proportion of a favorable state, a proportion of a favorable state with respect to duration, or the like) from temporal transition of the acquired biological information (a pulse, speech, an image, or the like). For example, the management server 50 may instruct the learning machine 60 illustrated in FIG. 1 to classify the state of the user from data obtained by vectorizing aggregate of the biological information in accordance with deep learning. The estimation result is, for example, reported to the management server 50 as the evaluation value which is classified into four stages. However, an index value estimating the state of the user is not limited to the evaluation values classified into four stages. The index value may be information for at least specifying whether the user who is executing work is put into a state where the user needs a break. Note that, when the state of the user who is executing work is estimated, it is also possible to take into account the work schedule, the utilization time, or the like, acquired as the vehicle attribute information. Further, the management server 50 may execute estimation algorithm of the learning machine 60 to estimate the state of the user who is executing work on the basis of the acquired biological information.

The management server 50 stores the evaluation value indicating the state of the user which is the estimation result in the work support management DB 503 (S14). The management server 50 stores the evaluation value indicating the state of the user in a state field in a row corresponding to the biological information, in the user state management information. After the processing in S14, the processing illustrated in FIG. 17 is finished.

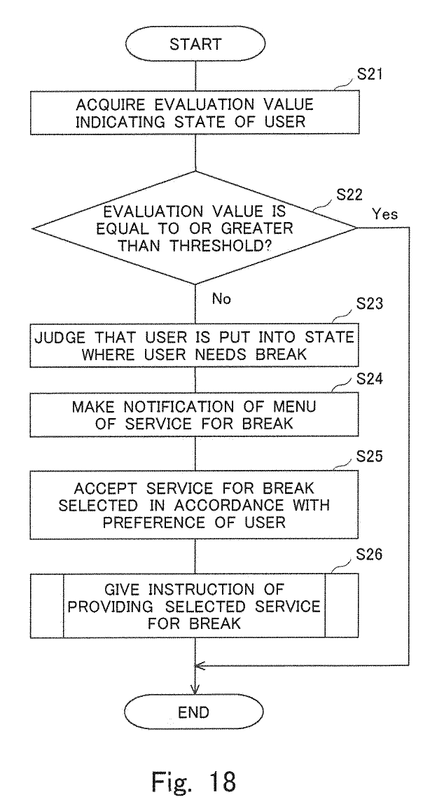

FIG. 18 will be described next. FIG. 18 is a flowchart illustrating an example of processing relating to provision of service for a break. In an example illustrated in the flowchart in FIG. 18, the processing is started at a predetermined timing at which the state of the user who is executing work is estimated on the basis of the biological information. The management server 50 acquires an estimation value indicating the state of the user estimated on the basis of the biological information (S21). The management server 50 then determines whether the acquired evaluation value is equal to or greater than a predetermined threshold (S22). Here, the predetermined threshold is a threshold for judging whether the user who is executing work is put into a state where the user needs a break. For example, in the evaluation values classified into four stages illustrated in FIG. 15, the evaluation value of “3” indicating a slightly favorable state becomes a threshold for judging whether the user is put into a state where the user needs a break.

In the case where the evaluation value indicating the state of the user is equal to or greater than the predetermined threshold (S22: “Yes”), the management server 50 judges that it is possible to continuously execute work, and finishes the processing illustrated in FIG. 18. Meanwhile, in the case where the evaluation value indicating the state of the user is less than the predetermined threshold (S22: “No”), the management server 50 judges that the user is put into a state where the user needs a break (S23). The management server 50 notifies the office vehicle 30W of menu of the service for a break which can be provided via the office vehicle (S24). The management server 50, for example, makes a notification of the menu of the service for a break illustrated in FIG. 11 along with a recommendation for encouraging the user to temporarily stop the work which is being executed and have a break through a speech message and a display message. The recommendation for encouraging the user to have a break is, for example, presented via the display 16 and the speaker 1G. Further, the menu of the service for a break is displayed at the display with the touch panel 16A. Here, the processing in S22 to be executed by the management server 50 is one example of a “judging unit that judges whether a user needs a break on the basis of user information relating to the user who is executing work within a first mobile body”.

The office vehicle 30W, for example, accepts operation input from the user with respect to the menu of the service for a break displayed at the display with the touch panel 16A, and specifies an item of the service for a break selected from the menu. The office vehicle 30W transmits the item of the service for a break selected in accordance with preference of the user to the management server 50 connected to the network N via the communication unit 15. In the example in FIG. 11, an item of the “relaxing environment (5021)”, the “healing image/music (5022)”, the “news (5023)” and the “utilization of store (5024)” selected from the menu is transmitted to the management server 50.

In the processing in S25 in FIG. 18, the management server 50 accepts the item of the service for a break which is selected in accordance with preference of the user, and which is transmitted from the office vehicle 30W. The management server 50 then gives an instruction of providing the service for a break selected in accordance with preference of the user (S26). For example, the office vehicle 30W is notified of a control instruction of adjusting the environment state. Further, acoustic data, image data, image and speech of a news are distributed to the office vehicle 30W. The center server 20 which cooperates with the management server 50 is notified of a meeting command for meeting the office vehicle 30W, issued for the store vehicle 30S which provides tea, massage, sauna, shower, or the like. After the processing in S26, the processing illustrated in FIG. 18 is finished.

Here, the processing in S26 executed by the management server 50 is one example of a “managing unit that instructs the first mobile body to provide predetermined service to a user when it is judged that the user needs a break”.

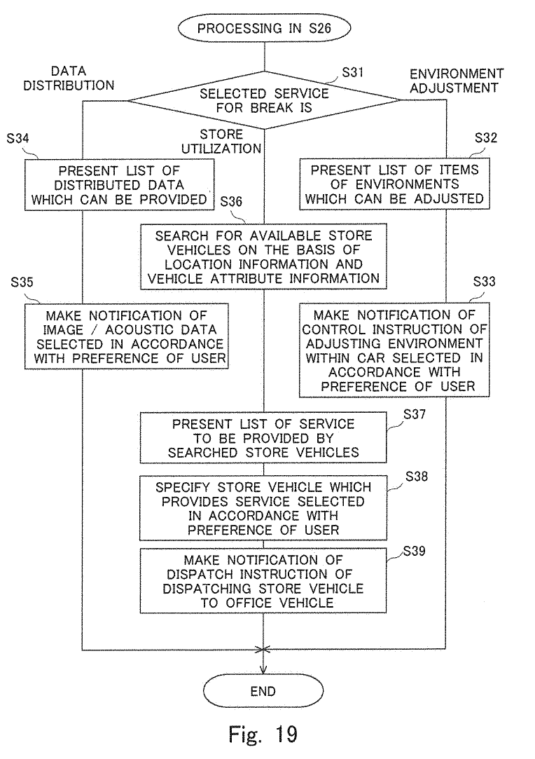

FIG. 19 will be described next. FIG. 19 is a flowchart illustrating an example of detailed processing of the processing in S26. By the processing illustrated in FIG. 19, service of adjusting an environment in a car, service of distributing acoustic data, image data, news, or the like, or service of tea, massage, sauna, shower, or the like, utilizing the store vehicle 30S in accordance with preference of the user is provided to the user who is executing work, and who is judged to be in a state where the user needs a break.

In the flowchart in FIG. 19, the management server 50 determines the service for a break selected by the user (S31). In the case where the selected service for a break is service of adjusting the environment state within the office vehicle 30W (S31: “environment adjustment”), the processing of the management server 50 transitions to processing in S32. Further, in the case where the selected service for a break is service of distributing acoustic data, image data, news, or the like (S31: “data distribution”), the processing of the management server 50 transitions to processing in s34. Still further, in the case where the selected service for a break is service of tea, massage, sauna, shower, or the like, utilizing the store vehicle 30S (S31: “utilization of store”), the processing of the management server 50 transitions to processing in S36.

(Provision of Environment Adjustment Service)

In the processing in S32, the management server 50 notifies the office vehicle of a list of items of environments which can be adjusted at the office vehicle 30W. At the office vehicle 30W, for example, the list of items of environments which can be adjusted is presented to the user via the display 16, the display with the touch panel 16A and the speaker 1G. At the office vehicle 30W, the list of items of environments which can be adjusted via the environment adjusting unit 1K is presented.

The office vehicle 30W, for example, accepts operation input from the user with respect to the list of items of environments displayed at the display with the touch panel 16A. Further, the office vehicle 30W accepts a selection instruction from the list of items of environments displayed at the display 16 using speech via the microphone IF and a selection instruction of an item of an environment notified via the speaker 1G using speech. The office vehicle 30W transmits the item of the environment selected in accordance with preference of the user to the management server 50. The management server 50 receives the item of the environment which is selected in accordance with preference of the user and which is transmitted from the office vehicle 30W.

In the processing in S33, the management server 50 notifies the office vehicle 30W of a control instruction of adjusting the environment within the car selected in accordance with preference of the user. The management server 50, for example, notifies the office vehicle 30W of a control instruction of controlling at least one of: lighting, daylighting, and air conditioning within the office vehicle, view of outside from the office vehicle 30W, and a height and tilt of the chair. The environment adjusting unit 1K of the office vehicle 30W controls a light adjusting unit K1, a daylighting control unit K2, a curtain control unit K3, an air conditioning control unit K5 and a chair control unit K6 in accordance with the notified control instruction to adjust the environment within the car to a state appropriate for a break. After the processing in S33, the processing illustrated in FIG. 19 is finished.

(Provision of Distribution Service)

In the processing in S34, the management server 50 notifies the office vehicle of a list of distributed data which can be provided at the office vehicle 30W. The management server 50, for example, acquires information of a channel in which acoustic data, image data, image and speech of a news are to be provided with reference to the distributed data management information in the work support management DB 503. The management server 50 then makes a notification of the acquired distributed data management information as a list. For example, the distributed data management information described using FIG. 14 is notified. At the office vehicle 30W, for example, a list of distributed data which can be provided is presented to the user via the display 16, the display with the touch panel 16A or the speaker 1G.

The office vehicle 30W accepts operation input from the user with respect to the list of distributed data in similar manner to provision of the environment adjustment service. The office vehicle 30W transmits the item of distributed data selected in accordance with preference of the user to the management server 50. The management server 50 receives the item of distributed data which is selected in accordance with preference of the user, and which is transmitted from the office vehicle 30W.

In the processing in S35, the management server 50 notifies the office vehicle 30W of the distributed data such as the image data and the acoustic data selected in accordance with preference of the user. The environment adjusting unit 1K of the office vehicle 30W controls a volume control unit K4 and a display control unit K7 to reproduce the notified distributed data. The reproduced distributed data is provided to the user via acoustic equipment such as the display 16 and the speaker 1G. At the office vehicle 30W, it is possible to provide service for a break of allowing the user to get refreshed via the distributed data selected in accordance with preference of the user.

(Provision of Store Utilization Service)

In the processing in S36, the management server 50 searches for the store vehicle 30S which is available to the user on the basis of the location information of the store vehicle 30S and the office vehicle 30W, and the vehicle attribute information of the store vehicle 30S with reference to the work support management DB 503. As a result of the search, a plurality of store vehicles 30S located around the office vehicle 30W are searched for. The management server 50 extracts types of service and lines of goods which can be provided from the store vehicle information of the searched store vehicle 30S and generates a list of service which can be provided to the user. The management server 50 then notifies the office vehicle 30W of the generated list of service to be provided by each store vehicle (S37). At the office vehicle 30W, for example, the list of service to be provided by each store vehicle is presented to the user via the display 16, the display with the touch panel 16A or the speaker 1G.

The office vehicle 30W accepts operation input from the user with respect to the list of service to be provided by each store vehicle in a similar manner to provision of the environment adjustment service. The office vehicle 30W transmits service utilizing the store vehicle 30S selected in accordance with preference of the user to the management server 50. The management server 50 receives the service utilizing the store vehicle 30S selected in accordance with preference of the user.

In the processing in S38, the management server 50 specifies the store vehicle 30S which provides the service selected in accordance with preference of the user. The store vehicle 30S which provides tea service of providing light meal, tea, coffee, or the like, or service of massage, sauna, shower, or the like, is specified.

The management server 50 extracts a vehicle ID of the specified store vehicle 30S from the store vehicle information and generates a dispatch instruction of dispatching the store vehicle to the office vehicle 30W (S39). The dispatch instruction includes, for example, vehicle IDs of the store vehicle 30S and the office vehicle 30W, and an instruction of instructing the store vehicle 30S to “provide tea service” to the office vehicle 30W. The management server 50 notifies the center server 20 with which the management server 50 cooperates of the generated dispatch instruction. After the processing in S39, the processing illustrated in FIG. 19 is finished.

As described above, it is possible to manage the state of the user who is executing work within the office vehicle on the basis of the user information including the biological information, work schedule, or the like, in the work support system 1 of the present embodiment. When it is judged that the user who is executing work is put into a state where the user needs a break, the work support system 1 provides predetermined service for a break to the user in accordance with preference.

For example, the work support system 1 of the present embodiment can judge whether the user who is executing work within the office vehicle needs a break on the basis of transition and change of a state indicated by the biological information included in the user information.

For example, the management server 50 of the work support system 1 notifies the office vehicle 30W of a control instruction of controlling brightness of lighting, and dimming within the vehicle, daylighting from outside, view from the office vehicle, a temperature, humidity, and an air volume of air conditioning within the office vehicle, tilt of the chair within the office vehicle, and the like. At the office vehicle 30W, the corresponding lighting, curtains, window shades, air conditioner, chair, or the like, are controlled in accordance with the control instruction, so that it is possible to provide an environment state appropriate for a break.

Further, for example, the management server 50 notifies the office vehicle 30W of distributed data such as acoustic data such as sound and music, image data and news. At the office vehicle 30W, the distributed data is reproduced via acoustic equipment such as the display and the speaker, so that it is possible to provide service for a break for allowing the user to get refreshed.

Further, for example, the management server 50 instructs the store vehicle 30S which provides tea such as light meal, tea and coffee, massage, sauna, shower, or the like, to meet the office vehicle 30W and provide store service of the own vehicle to the user. At the office vehicle 30W, it is possible to allow the user to utilize the store service via the met store vehicle 30S. According to the work support system 1 of the present embodiment, it is possible to provide a support technique which enables the user to appropriately execute predetermined work within the mobile body.

### Modified Example

While, in the processing in the above-described S13, to estimate the state of the user who is executing work, a processing example by deep learning has been described, the processing is not limited to this. For example, it is also possible to judge whether the user needs a break in accordance with duration of work of the user, behavior for determining fatigue, such as yawning, frequency of a time period while the eyelid is closed exceeding a predetermined time period, or the like. The management server 50, for example, specifies interruption of work by the user on the basis of the image acquired via the image sensor 1H. For example, action that the user leaves the chair C1 on which the user is seated is specified as interruption of work through image recognition. In a similar manner, yawning and opening and closing of the eyelid are specified from change of a mouth portion, change of an eye portion, tilt of the face in a front-back direction and in a right and left direction, or the like, in the face image. The management server 50 then may calculate an evaluation value based on frequency of the above-described behavior, or the like, within a predetermined time period as a point.

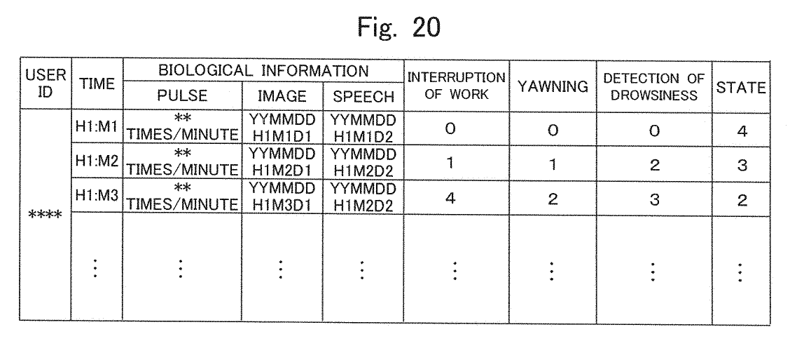

FIG. 20 is a diagram explaining user state management information in the modified example. In FIG. 20, in addition to the user state management information illustrated in FIG. 15, duration of work based on the image acquired from the image sensor 1H, the above-described behavior (biological phenomenon) for determining fatigue, or the like, are managed. In FIG. 20, respective fields of interruption of work, yawning and detection of drowsiness are further provided. The interruption of work indicates the number of times of interruption of work per unit time counted from the image. The yawning indicates the number of times of yawning per unit time counted from the image. The detection of drowsiness indicates the number of times of detection of drowsiness per unit time counted assuming that a state where a time period while the eyelid is closed exceeds a predetermined time period is specified as detection of drowsiness in the image. Note that, in a state field in FIG. 20, an evaluation value based an a count value stored in each field of the interruption of work, the yawning and the detection of drowsiness, is stored.

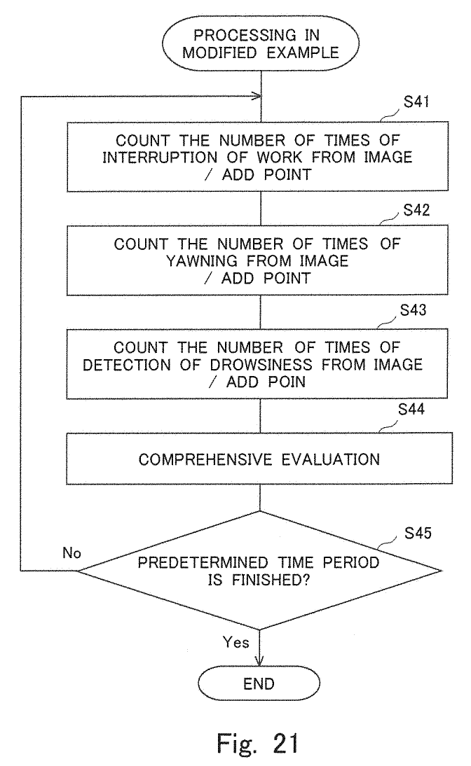

FIG. 21 is a flowchart illustrating an example of processing in the modified example. The processing in FIG. 21 is executed on an image acquired in a predetermined time period. In processing in S41, the management server 50 specifies action regarding interruption of work by the user from the image acquired by the office vehicle 30W and counts the action. The management server 50 then weights the counted number of times of interruption of work and calculates a point value for evaluating the state of the user. For example, when the counted number of times of interruption of work is set as “NBR”, and a weighting coefficient is set as “w1”, the point value can be expressed as “NBR×w1”.

In processing in S42, a point value with respect to the counted number of times of yawning, which is obtained by counting the number of times of yawning specified from the image is calculated in a similar manner. The point value “NA×w2” in which the counted number of times of yawning is set as “NA”, and a weighting coefficient is set as “w2”, is calculated. In a similar manner, also in processing in S43, a point value (“NS×w3”) obtained with the number of times of detection of drowsiness (“NS”) counted from the image and a weighting coefficient (“w3”) is calculated.

The management server 50 then performs comprehensive evaluation indicating the state of the user who is executing predetermined work, on the basis of the respective point values calculated in the processing from S41 to S43 (S44). The result of the comprehensive evaluation is, for example, expressed as an evaluation value classified into four stages to be stored in the state field of the user state management information. For example, the management server 50 adds up the respective point values calculated in processing from S41 to S43 to calculate a total point value. The management server 50 then, for example, may classify the calculated total point value less than “5” into the evaluation value of “4” indicating a favorable state for executing work. In this case, for example, the total point value of “from 5 to 10” is classified into the evaluation value of “3” indicating a slightly favorable state, the total point value of “from 10 to 20” is classified into the evaluation value of “2” indicating a slightly fatigued state, and the total point value equal to or greater than “20” is classified into the evaluation value of “1” indicating a fatigued state. The management server 50 stores the evaluation result in the state field of the user state management information illustrated in FIG. 20. However, a reference value for classifying the total point value may be adjusted as appropriate in accordance with the weighting coefficients w1, w2 and w3.

Further, the management server 50 may calculate average duration of work in a predetermined time period from the counted number of times of interruption of work (NBR). Here, the calculated average duration of work is indicated as (predetermined time period/the number of times of interruption of work). The management server 50 then may classify the state of the user on the basis of the average duration of work.

In S45, the management server 50 determines elapse of the predetermined time period, and, in the case where the predetermined time period is finished (S45: “Yes”), finishes the processing illustrated in FIG. 21. Meanwhile, in the case where the predetermined time period is not finished (S45: “No”), the management server 50 continues the processing from S41 to S45.

As described above, in the work support system 1 of the present embodiment, it is possible to determine that the user who is executing work is put into a state where the user needs a break on the basis of at least one of the number of times of occurrence of a biological phenomenon in the biological information per unit period and a proportion of a work period which is determined from the image in an elapsed time period.

[Computer Readable Recording Medium]

It is possible to record a program which causes a computer, or other machine, apparatuses (hereinafter, a computer, or the like) to implement one of the above-described functions in a computer readable recording medium. Then, by causing the computer, or the like, to load and execute the program in this recording medium, it is possible to provide the function.

Here, the computer readable recording medium refers to a non-transitory recording medium in which information such as data and programs is accumulated through electric, magnetic, optical, mechanical or chemical action and from which the information can be read from a computer, or the like. Among such a recording medium, examples of a recording medium which is detachable from the computer, or the like, can include, for example, a flexible disk, a magneto-optical disk, a CD-ROM, a CD-R/W, a DVD, a blu-ray disk, a DAT, an 8 mm tape, a memory card such as a flash memory, or the like. Further, examples of a recording medium fixed at the computer, or the like, can include a hard disk, a ROM (read only memory), or the like. Still further, an SSD (Solid State Drive) can be utilized both as a recording medium which is detachable from the computer, or the like, and a recording medium which is fixed at the computer, or the like.

What is claimed is:

1. A work support system which supports execution of work of a user using predetermined facility in a first mobile body including the predetermined facility among one or more mobile bodies, the work support system comprising:
a judging unit configured to judge whether a user needs a break on a basis of user information relating to the user who is executing work within the first mobile body; and
a managing unit configured to instruct the first mobile body to provide predetermined service to the user when it is judged that the user needs a break.

2. The work support system according to claim 1,
wherein the user information includes at least biological information acquired from the user who is executing work within the first mobile body.

3. The work support system according to claim 2,
wherein the user information includes acquired time, and the biological information includes an image acquired from the user, and
the judging unit judges whether or not the user needs a break on a basis of at least one of the number of times of occurrence of a biological phenomenon in the acquired biological information per unit period and a proportion of a work period which is determined from the image in an elapsed time period.

4. The work support system according to claim 1,
wherein, when it is judged that the user needs a break, the managing unit notifies the first mobile body of one of acoustic data, image data and news data selected in accordance with preference of the user.

5. The work support system according to claim 1,
wherein, when it is judged that the user needs a break, the managing unit notifies the first mobile body of a control instruction of controlling at least one of: lighting, daylighting, and air conditioning within the first mobile body, view from the first mobile body, and tilt of a chair to be used by the user in accordance with preference of the user.

6. The work support system according to claim 1,
wherein, when it is judged that the user needs a break, the managing unit instructs a second mobile body which is able to provide goods or service among the one or more mobile bodies to provide the goods or the service to the user within the first mobile body.

7. An information processing method to be executed by a computer of a work support system which supports execution of work of a user using predetermined facility in a first mobile body including the predetermined facility among one or more mobile bodies, the information processing method comprising:
a step of judging whether a user needs a break on a basis of user information relating to the user who is executing work within the first mobile body; and
a step of instructing the first mobile body to provide predetermined service to the user when it is judged that the user needs a break.

8. A non-transitory storage medium stored with a program causing a computer of a work support system which supports execution of work of a user using predetermined facility in a first mobile body including the predetermined facility among one or more mobile bodies, to execute:
a step of judging whether a user needs a break on a basis of user information relating to the user who is executing work within the first mobile body; and
a step of instructing the first mobile body to provide predetermined service to the user when it is judged that the user needs a break.
